(19) United States
(12) Patent Application Publication
(10) Pub. No.: US 2002/0114128 A1
(43) Pub. Date: Aug. 22, 2002

(54) Redox supercapacitor and manufacturing method thereof

(76) Inventors: Kwang Sun Ryu, Taejon (KR); Kwang Man Kim, Taejon (KR); Yong-Joon Park, Taejon (KR); Nam-Gyu Park, Taejon (KR); Soon Ho Chang, Taejon (KR)

Correspondence Address: JACOBSON HOLMAN, PLLC., PROFESSIONAL LIMITED LIABILITY COMPANY, 400 Seventh Street, N.W., Washington, DC, 20004, US

(21) Appl. No.: 10/015,890

(22) Filed: Dec. 17, 2001

(30) Foreign Application Priority Data
Dec. 18, 2000 (KR) 2000-77836

(51) Int. Cl. H01G 9/04; H01G 9/145

(52) U.S. Cl. 361/508

(57) ABSTRACT

The redox supercapacitor of the present invention utilizes a conducting polyaniline doped with lithium salt, protonic acid, or nucleophilic dopant for fabricating an active electrode, thereby reducing a surface resistance and simplifying fabrication steps. The redox supercapacitor includes a positive electrode plate incorporating therein an electrode active material provided with a polyaniline powder doped with a lithium salt, protonic acid, or nucleophilic dopant, a negative electrode plate incorporating therein an electrode active material provided with a polyaniline powder doped with a lithium salt, protonic acid, or nucleophilic dopant and a polymer electrolyte membrane disposed between the positive electrode plate and the negative electrode plate.

### FIELD OF THE INVENTION

The present invention relates to a redox supercapacitor; and, more particularly, to a redox supercapacitor and a method for manufacturing the same by utilizing a conducting polyaniline doped with lithium salt, proton acid or nucleophilic dopant for manufacturing an active material, wherein active electrodes and a separator are a unitary shape.

### DESCRIPTION OF THE PRIOR ART

In recent years, as a modern society becomes a high-information society, an information communication system with a high reliability is required. Furthermore, it is necessary for securing a stable electrical energy. Thus, various researches for solar energy, wind energy and a hybrid vehicle have been advanced. In addition, an enhanced energy accumulation system is demanded for an effective power system. A lithium secondary cell, a supercapacitor and a solar cell have been developed as the power system satisfying the security of the stable electrical energy and the enhanced energy supply system. In particular, since the supercapacitor generates high energy in a short time, the supercapacitor is in the limelight of an energy accumulation system.

Generally, the capacitor is mainly divided into three types, i.e., an electrostatic capacitor, an electrolytic capacitor and an electrochemical capacitor. Among these, the electrostatic capacitor has a high voltage charge/discharge property in spite of a low capacitance. Furthermore, the electrostatic capacitor has a rapid discharge time in milliseconds so that the electrostatic capacitor is used for a high voltage short pulse power system. The electrolytic capacitor, which is called an electrolyte condenser, is conventionally applied to the power system up to now due to its high capacitance.

The electrochemical capacitor is referred to the supercapacitor or an ultracapacitor, in which a specific capacitance of the electrochemical capacitor is 100 times to 1,000 times higher than that of a conventional capacitor. In addition, a power density of the electrochemical capacitor is 10 times higher than that of a newest secondary cell and an energy density is approximately 10% of the newest secondary cell. Therefore, abundant energy can be stored rapidly so that the electrochemical capacitor is employed as the power supply source more and more nowadays.

The supercapacitor is divided mainly into an electrical double layer capacitor (EDLC) and a redox or a pseudo supercapacitor according to an operation mechanism. The ELDC is operated by a charge separation, wherein an active carbon is used as an electrode material. The redox supercapacitor is a chemical capacitor operated by a charge transportation. In comparison with the EDLC, the redox supercapacitor can be miniaturized and the specific capacitance per unit weight is 5 times to 10 times higher than that of the EDLC, whereby the redox supercapacitor may be used as a miniaturized high power energy source.

Generally, the redox supercapacitor comprises an active electrode including a metal oxide and a conductive polymer, a separator, an electrolyte, a charge collector and a case. Though the charge collector and the electrolyte are important elements to determine the capability of the redox supercapacitor, the capacitance and the voltage are mainly changed according to the kind of the active electrode materials so that the selection of the active electrode materials is most important matter. The electrode material should have a high conductivity and a high specific surface area. Moreover, it is preferable that the electrode material should be stable electrochemically and the price should not be expensive.

Researches for a conductive polymer electrode material has not been advanced yet. But nowadays, the researches are being promoted. For example, the research for the conductive polymer such as polypyrrole and polythiophene and its derivative is being progressed. In particular, among polythiophene derivative compounds, a research result for a particular material is announced of which the capacitance is about 100 F/g and the voltage is about 3 V using the material that can be an n-type dopant and a p-type dopant simultaneously.

Meanwhile, as the information society is developed, a future information telecommunication device that is capable of supplying a plurality of information, demands a miniaturized power source with high power and high efficiency. That is, the device such as an IMT-2000 device and a satellite telecommunication device demands the high-energy capacity and high efficiency. Since the increase of the energy density of the conventional battery reaches to its limitation, it is necessary to develop an auxiliary supercapacitor with high power outputted in milliseconds. To meet the demand, the redox supercapacitor is more preferable to the ELDC because the redox supercapacitor has the specific capacitance higher than that of the ELDC.

The redox supercapacitor utilizes reduction and oxidation reaction so that the lifetime is relatively shorter than that of the ELDC. However, the redox supercapacitor has advantages that the specific capacitance is high and the rapid high power can be generated in short time. Furthermore, the redox supercapacitor has a merit of the miniaturization of the device.

The conventional redox supercapacitor and the ELDC are mainly fabricated by pressurizing an electrode plate and the separator physically, wherein the electrode plate and the separator are separated from each other. In general, the conventional manufacturing process begins with preparing a mixture by mixing an active carbon, an inorganic oxide or a conductive polymer with a binder. Thereafter, the charge collector or a non-woven fabric is doped with the prepared mixture. Finally, the charge collector and the separator are joined together by using an exterior case or a tightening apparatus. In accordance with the conventional manufacturing method as aforementioned, the rigid case is required for joining together or the capacitor should be fabricated into a roll type. As a result, there is a drawback that the shape of the capacitor is limited. In addition, there is a problem that an alignment process is needed additionally. Therefore, it is necessary to develop the method for forming the electrode and the conductive polymer with ease and the method for fabricating the redox supercapacitor incorporating therein the electrode and the conductive polymer.

### SUMMARY OF THE INVENTION

It is, therefore, an object of the present invention to provide a unitary redox supercapacitor using polyaniline doped with proton acid, lithium salt or nucleophilic dopant for fabricating an active electrode, thereby reducing a surface resistance and simplifying manufacturing steps.

It is, therefore, another object of the present invention to provide a method for manufacturing a unitary redox supercapacitor using polyaniline doped with proton acid, lithium salt or nucleophilic dopant for fabricating an active electrode, thereby reducing a surface resistance and simplifying manufacturing steps.

In accordance with one aspect of the present invention, there is provided a redox supercapacitor comprising: a positive electrode plate incorporating therein a charge collector and an electrode active material, wherein the electrode active material is made by using a conducting polyaniline powder; a negative electrode plate incorporating therein a charge collector and an electrode active material, wherein the electrode active material is made by using a conducting polyaniline powder; and a polymer electrolyte membrane disposed between the positive electrode plate and the negative electrode plate.

In accordance with another aspect of the present invention, there is provided a method for manufacturing a redox supercapacitor comprising the steps of: a) preparing an electrode active material including a conducting polyaniline therein; b) forming a positive and a negative electrode plates incorporating therein the electrode active material and charge collectors; and c) forming a polymer electrolyte membrane disposed between the positive and the negative electrode plates.

### BRIEF DESCRIPTION OF THE DRAWINGS

The above and other objects and features of the present invention will become apparent from the following description of the preferred embodiment given in conjunction with the accompanying drawings, in which:

FIG. 1 is a schematic view setting forth a process for manufacturing electrode active material slurry in order to fabricate an electrode plate directly in accordance with a preferred embodiment of the present invention;

FIG. 2 is a schematic view setting forth a process for manufacturing another electrode active material slurry in order to fabricate an electrode active material film in accordance with the present invention;

FIG. 3 is a schematic view illustrating the process for manufacturing an electrode plate by coating the electrode active material slurry directly on a charge collector in accordance with the present invention;

FIG. 4 is a schematic view representing the process for manufacturing the electrode plate by joining the electrode active material films and a charge collector together in accordance with the present invention;

FIGS. 5A to 5D are photographs depicting microstructures of the electrode plates and a polymer electrolyte membrane in accordance with the present invention;

FIGS. 6A and 6B are cross sectional views showing a unitary redox supercapacitor in accordance with the present invention;

FIGS. 7A and 7B are graphs setting forth discharge curves and specific capacitance curves of a redox supercapacitor incorporating therein a polyaniline electrode doped with lithium salt using a separator after charging and discharging 5,000 cycles in accordance with the present invention;

FIGS. 8A and 8B are graphs setting forth discharge curves and specific capacitance curves of a redox supercapacitor incorporating therein a polyaniline electrode doped with lithium salt using the polymer electrolyte membrane after charging and discharging 5,000 cycles in accordance with the present invention;

FIGS. 9A and 9B are graphs setting forth discharge curves and specific capacitance curves of a redox supercapacitor incorporating therein a polyaniline doped with proton acid and lithium salt using the polymer electrolyte membrane after charging and discharging 5,000 cycles in accordance with the present invention; and

FIGS. 10A and 10B are graphs setting forth discharge curves and specific capacitance curves of a redox supercapacitor incorporating therein a polyaniline electrode doped with dimethylsulfate (DSA) using the polymer electrolyte membrane after charging and discharging 5,000 cycles in accordance with the present invention.

### DETAILED DESCRIPTION OF THE PREFERRED EMBODIMENTS

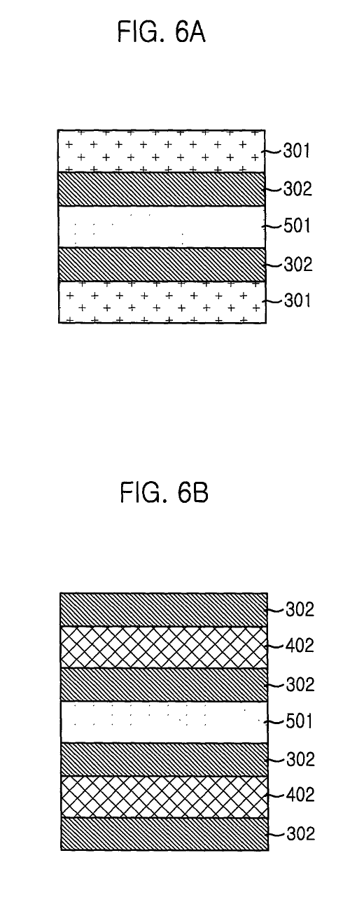

Referring to FIGS. 6A and 6B, there are shown cross sectional views setting forth redox supercapacitors in accordance with preferred embodiments of the present invention. The redox supercapacitor comprises a positive electrode plate, a negative electrode plate and a polymer electrolyte membrane 501 disposed between the positive and the negative electrode plates. The polymer electrolyte membrane 501 is obtained by drying a polymer film (not shown) coated with a polymer solution, wherein the polymer solution is prepared by dissolving polyvinylidene fluoride hexafluoropropylene (PVDF-HFP) polymer into acetone. The polymer electrolyte membrane 501 has characteristics that it can join the positive and the negative electrode plates and it has high ionic conductivity and a plurality of microporosities therein, whereby it is suitable for the separator.

The positive and the negative electrode plates are made by two processes. That is, one process is to coat an electrode active material slurry 302 on a foil-typed charge collector 301 directly, as depicted in FIG. 6A. The other process is to utilize the electrode active material film formed on the polymer film in advance. According to the latter process, an electrode active material slurry is coated on the polymer film in advance and it is dried in a moisture-free environment. Thereafter, the electrode active material film 302 is separated from the polymer film. Two electrode active material films 302 are formed on both sides of a mesh-typed charge collector 402, thereby obtaining the electrode plate, as shown in FIG. 6B.

The method for manufacturing the redox supercapacitor is illustrated in detail by referring to examples, hereinafter.

### EXAMPLES 1 to 6

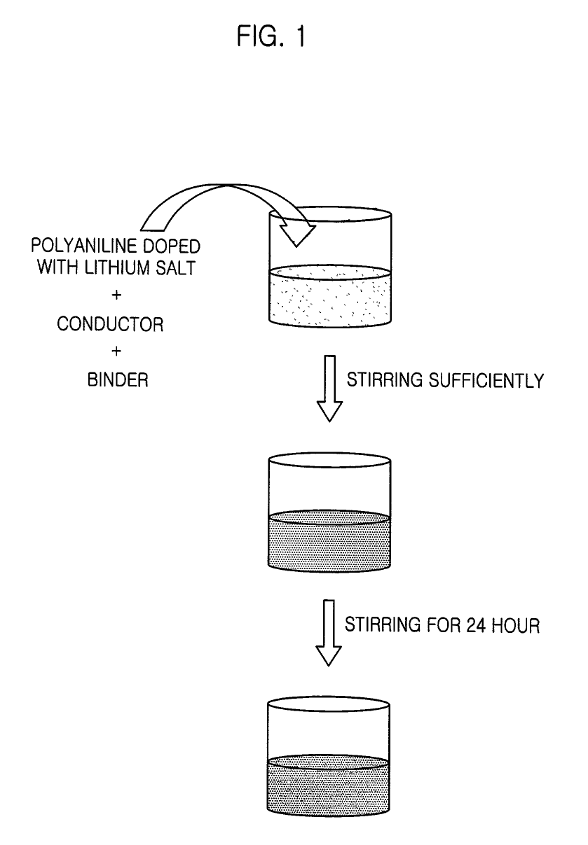

Referring to FIG. 1, there is shown a schematic view setting forth a fabrication process for an electrode active material slurry for coating the slurry on the charge collector directly in accordance with the present invention.

To begin with, polyaniline powder doped with lithium salt and a conductor are mixed together in a solid powder state for enhancing a mixing efficiency. Thereafter, the mixed powder is put into binder organic solution, e.g., KUREHA KF9130, and a solvent for organic solution, e.g., n-methylpyrrolidinone (NMP). Subsequently, a resultant mixture is stirred sufficiently using a stirrer. Here, LiPF₆, LiPF₄, NaPF₆ or NaBF₄ is used as lithium salt.

After the slurry has a suitable viscosity to be coated on a charge collector by adjusting the amount of the organic solution, the slurry is stirred again by means of a ball mill apparatus. The ball mill operation is carried out for approximately a day, whereby the electrode active material slurry is fabricated.

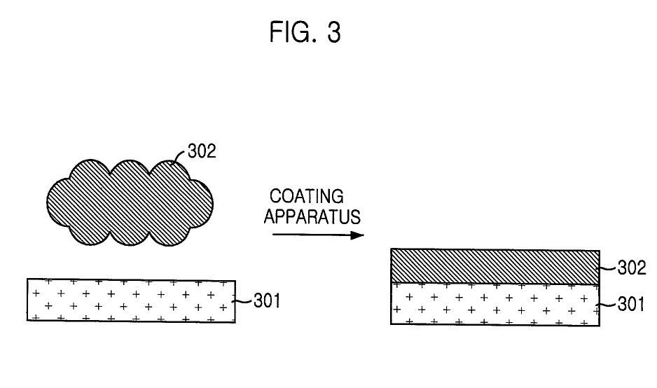

Referring to FIG. 3, there is shown a schematic view illustrating the process for manufacturing an electrode plate by coating the electrode active material slurry 302 directly on the charge collector 301 in accordance with the present invention. In FIG. 3, the electrode active material slurry 302 is coated directly on a foil-typed charge collector 301 with a uniform thickness using a coating apparatus. Thereafter, the charge collector 301 coated with the electrode active material slurry 302 is dried, thereby obtaining the electrode plate.

Experimental conditions for each example such as a composition ratio and each coating thickness are described in a following table 1.

TABLE 1

| | Ex. 1 | | Ex. 2 | | Ex. 3 | | Ex. 4 | | Ex. 5 | | Ex. 6 | |
|---|---|---|---|---|---|---|---|---|---|---|---|---|
| Li-doped | 0.d2 | g | 0.2 | g | 0.2 | g | 0.2 | g | 0.2 | g | 0.2 | g |
| Polyaniline | | | | | | | | | | | | |
| Conductor | 0.2 | g | 0.2 | g | 0.2 | g | 0.2 | g | 0.2 | g | 0.2 | g |
| (Super P) | | | | | | | | | | | | |
| Binder | 0.8 | g | 0.6 | g | 0.4 | g | 0.2 | g | 0.2 | g | 0.1 | g |
| PVDF | | | | | | | | | | | | |
| Total | 6.15 | g | 4.62 | g | 3.08 | g | 1.54 | g | 1.54 | g | 0.77 | g |
| NMP | 0 | g | 1 | g | 2 | g | 3 | g | 2 | g | 3 | g |
| Solvent | | | | | | | | | | | | |

| | | | | | | |
|---|---|---|---|---|---|---|
| Total(g) | 5.3505 | 5.0194 | 4.677 | 4.3398 | 3.3398 | 3.6692 |
| Thickness | 600 | 600 | 600 | 600 | 600 | 600 |
| (μm) | → 84 | → 98 | → 75 | → 156 | → 230 | → 135 |

Furthermore, the coating thickness of each example is kept to be approximately 600 μm while coating the slurry. The drying process is carried out at approximately 80° C.

The experimental results for each example result in followings: the example 1 shows that the foil is wrinkled severely; the example 2 shows that the foil is wrinkled also; the example 3 shows that there is still wrinkles on the foil but better than the results of the examples 1 and 2; the example 4 gives the best result that there is no wrinkle and no drop of the active material; the example 5 shows that the foil has rough surface thereof; and the example 6 shows that the active material is dropped off from the foil.

From the above results, it is understood that the optimized weight ratio among the electrode active material, the conductor, the PVDF and the NMP, is 1:1:1:15 respectively.

### EXAMPLES 7 to 15

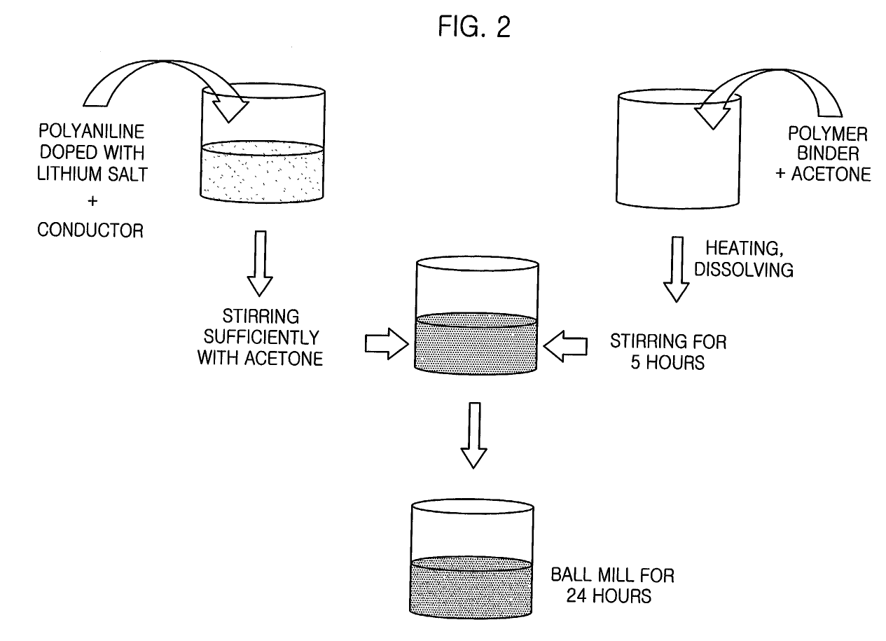

Referring to FIG. 2, there is shown a schematic view setting forth a process for manufacturing another electrode active material slurry in order to fabricate an electrode active material film in accordance with the present invention.

To begin with, polyaniline powder doped with lithium salt or proton acid and a conductor are mixed together in a solid powder state for enhancing the mixing efficiency. Thereafter, the mixed powder is put into acetone solution in which polyvinylidene fluoride and hexafluoropropylene (PVDF-HFP) is dissolved. Thereafter, the resultant mixture is stirred sufficiently for approximately 5 hours using the stirrer.

After the slurry has a suitable viscosity to be coated on by adjusting the amount of the organic solution, the slurry is stirred again by means of a ball mill apparatus. The ball mill operation is carried out for approximately a day, whereby the electrode active material slurry is fabricated.

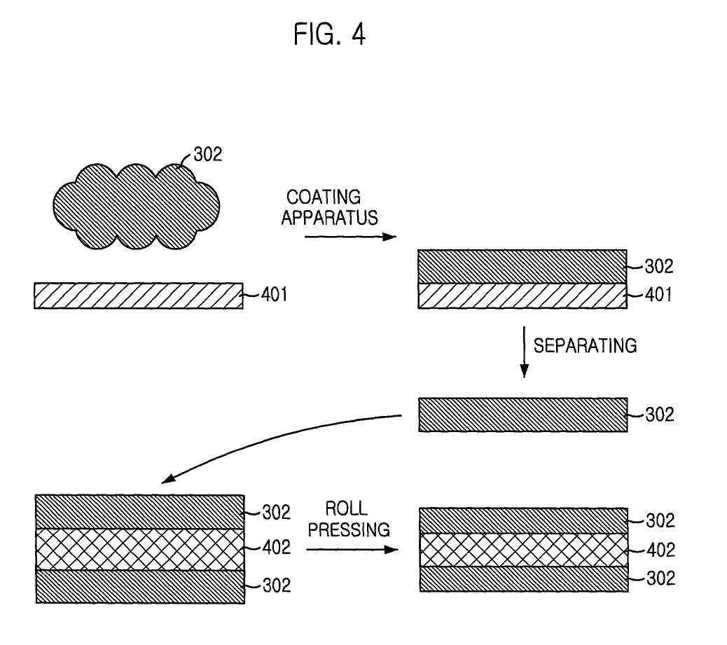

Referring to FIG. 4, there is shown a schematic view setting forth the process for manufacturing the electrode plate by joining the electrode active material films 302 and a charge collector 402 together in accordance with the present invention. To begin with, the electrode active material slurry is coated on a polymer film 401 with uniform thickness and the polymer coated with the electrode active material slurry is dried, thereby obtaining an electrode active material film 302. In an ensuing step, the electrode active material film 302 is separated from the polymer film 401 in moisture-free environment. Next, the electrode active material films 302 obtained as described above are disposed on both surfaces of a mesh-typed charge collector 402. Finally, the charge collector 402 and the electrode active material films 302 are laminated by means of a roll press apparatus, thereby obtaining an electrode plate where the electrode active material films are attached on both surfaces thereof.

Experimental conditions for examples 7 to 11 such as a composition ratio and each coating thickness are described in a following table 2, wherein each example is made by using polyaniline doped with lithium salt.

TABLE 2

| | Ex. 7 | Ex. 8 | Ex. 9 | Ex. 10 | Ex. 11 |
|---|---|---|---|---|---|
| Li-doped | 0.2 g | 0.2 g | 0.2 g | 0.2 g | 0.2 g |
| Polyaniline | | | | | |
| Conductor | 0.2 g | 0.2 g | 0.2 g | 0.2 g | 0.2 g |
| Binder | 0.2 g | 0.15 g | 0.1 g | 0.08 g | 0.06 g |
| Thickness | 600 | 600 | 600 | 600 | 600 |
| (μm) | → 140 | → 95 | → 140 | → 150 | → 110 |

Furthermore, the coating thickness of each example is kept to be approximately 600 μm while coating the slurry. The drying process is carried out at approximately 80° C.

The experimental results for each example result in followings: the example 7 shows that the film is shrunk due to the abundant amount of PVDF-HFP; the example 8 shows that the film is still shrunk; the example 9 gives the best result that the film is shrunk a little but the surface of the film is smooth; the example 10 shows that the surface of the film is pierced to form a hole therein; and the example 11 shows that there is the hole pierced through the surface of the film and the active material slurry is likely to be dropped off therefrom.

From the above results, it is understood that the optimized weight ratio among the polymer active material, the conductor and the PVDF-HFP, is 2:2:1 respectively. At this time, the acetone used for dissolving the PVDF-HFP should be added to a predetermined amount that the coated film of the slurry is not flowed down, whereby it is difficult to determine the amount of the acetone. Moreover, it is also difficult to determine the amount of the acetone due to the volatile characteristic of the acetone.

Meanwhile, experimental conditions for examples 12 to 15 such as a composition ratio and each coating thickness are described in a following table 3, wherein each example is made by using polyaniline doped with proton acid.

TABLE 3

| | Ex. 12 | Ex. 13 | Ex. 14 | Ex. 15 |
|---|---|---|---|---|
| HCl-doped | 0.48 g | 0.42 g | 0.39 g | 0.36 g |
| Polyaniline | | | | |
| Conductor | 0.32 g | 0.28 g | 0.26 g | 0.24 g |
| Binder | 0.2 g | 0.3 g | 0.35 g | 0.4 g |
| Thickness | 600 | 600 | 600 | 600 |
| (μm) | → 130 | → 127 | → 125 | → 122 |

The coating thickness of each example is kept to be approximately 600 μm while coating the slurry. The drying process is carried out at approximately 80° C.

The experimental results for each example result in followings: the example 12 shows that there is shown a plurality of cleavages therein; the example 13 shows that a little hole happened; the example 14 gives the best result that the film is shrunk a little; the example 15 shows that the film is well fabricated but the amount of the binder can be reduced.

From the above results, it is understood that the optimized weight ratio among the polymer active material, the conductor and the PVDF-HFP, is 1.5:1:1.35 respectively. At this time, the acetone used for dissolving the PVDF-HFP should be added to a predetermined amount that the coated film of the slurry is not flowed down, whereby it is difficult to determine the amount of the acetone. Moreover, it is also difficult to determine the amount of the acetone due to the volatile characteristic of the acetone.

### EXAMPLES 16 to 19

The examples 16 to 19 utilize nucleophilic dopant in fabricating the electrode active material slurry.

To begin with, polyaniline powder doped with nucleophilic dopant and a conductor are mixed together in a solid powder state for enhancing the mixing efficiency. Thereafter, the mixed powder is put into acetone solution in which PVDF-HFP is dissolved. Thereafter, the resultant mixture is stirred sufficiently for approximately 5 hours using the stirrer.

After the slurry has a suitable viscosity to be coated on by adjusting the amount of the organic solution, the slurry is stirred again by means of the ball mill apparatus. The ball mill operation is carried out for approximately a day, whereby the electrode active material slurry is fabricated.

Referring to FIG. 4, there is shown a schematic view setting forth the process for manufacturing the electrode plate by joining the electrode active material films 302 and a charge collector 402 together in accordance with the present invention. To begin with, the electrode active material slurry is coated on a polymer film 401 with uniform thickness and the polymer film 401 coated with the electrode active material slurry is dried, thereby obtaining an electrode active material film 302. In an ensuing step, the electrode active material film 302 is separated from the polymer film 401 in moisture-free environment. Next, the electrode active material films 302 obtained as described above are disposed on both surfaces of a mesh-typed charge collector 402. Finally, the charge collector 402 and the electrode active material films 302 are laminated by means of a roll press apparatus, thereby obtaining an electrode plate where the electrode active material films are attached on both surfaces thereof.

Experimental conditions for each example such as a composition ratio and each coating thickness are described in a following table 4.

TABLE 4

| | Ex. 16 | Ex. 17 | Ex. 18 | Ex. 19 |
|---|---|---|---|---|
| DMS-doped | 2.8 g | 2.8 g | 2.8 g | 2.8 g |
| Polyaniline | | | | |
| Conductor | 1.2 g | 1.2 g | 1.2 g | 1.2 g |
| Binder | 2.2 g | 2.4 g | 2.8 g | 3.2 g |
| Thickness | 400 | 400 | 400 | 400 |
| (μm) | → 61 | → 50 | → 108 | → 43 |

The coating thickness of each example is kept to be approximately 400 μm while coating the slurry. The drying process is carried out at approximately 80° C.

The experimental results for each example result in followings: the example 16 shows that the surface is coated with slurry thinly, there is happened a cleavage therein and the film has a rough surface thereof but the mixing is well done; the example 17 shows that there are clusters therein, the film is well fabricated, the film is easy to be broken down in case of stretching the film with a hand but the state of the film is good; the example 18 shows that there are clusters therein also but the film is well fabricated; and the example 19 shows that the mixing state is good and the film is well fabricated but the abundant binder is used.

From the above results, it is understood that the optimized weight ratio among the polymer active material, the conductor and the PVDF-HFP, is 7:3:6 respectively. At this time, the acetone used for dissolving the PVDF-HFP should be added to a predetermined amount that the coated film of the slurry is not flowed down, whereby it is difficult to determine the amount of the acetone. Moreover, it is also difficult to determine the amount of the acetone due to the volatile characteristic of the acetone.

### EXAMPLE 20

The preparation for the polymer electrolyte membrane 501 used as the separator begins with mixing polymer solution with inorganic filler, i.e., silica (SiO₂) sufficiently, wherein the polymer solution is prepared by dissolving PVDF-HFP polymer into acetone. Thereafter, the mixed polymer solution is coated on a support polymer film (not shown) with uniform thickness and it is dried. Subsequently, the dried mixed polymer solution is separated from the support polymer film, thereby obtaining the polymer electrolyte membrane 501. Here, the weight percent ratio between PVDF-HFP and SiO₂ is about 1:0.2 in fabricating the polymer electrolyte membrane 501. The thickness of the polymer electrolyte membrane 501 is approximately 30 μm and the ionic conductivity is approximately 3×10⁻³ S/cm. The polymer electrolyte membrane 501 plays a role in joining a positive and a negative electrode plates on both sides thereof. Additionally, the polymer electrolyte membrane 501 has high ionic conductivity and a plurality of microporosities therein so that it is suitable for the separator. After the prepared polymer electrolyte membrane 501 is cut out to be a desired shape, the polymer electrolyte membrane 501 is utilized for manufacturing the capacitor.

### EXAMPLE 21

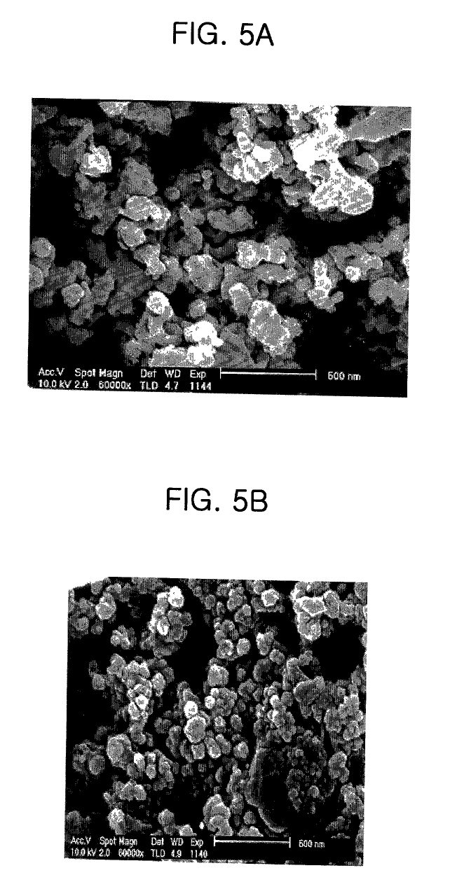

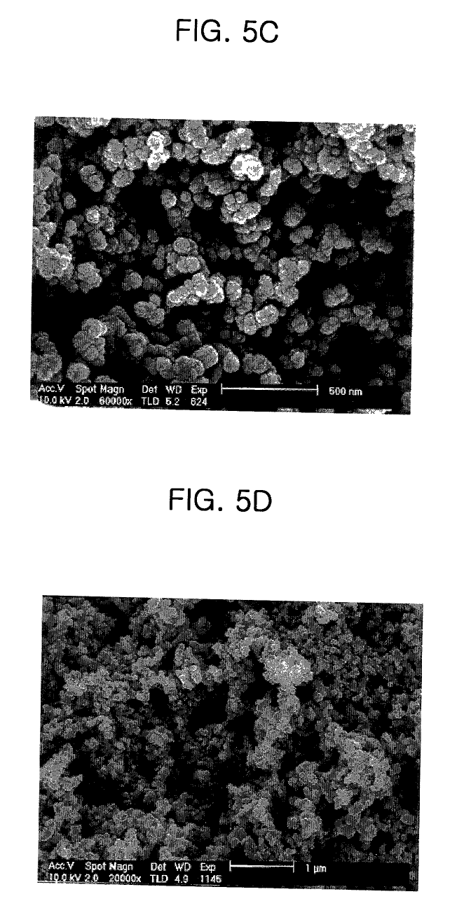

Referring to FIGS. 5A to 5D, there are photographs setting forth microstructures of the electrode plates and the polymer electrolyte membrane 501 in accordance with the present invention.

FIG. 5A, 5B and 5C represent microstructures of the electrode plates fabricated by using polyaniline doped with lithium salt, polyaniline doped with proton acid and polyaniline doped with nucleophilic dopant, respectively. From these photographs, it is understood that the electrode active material polymer and the conductor are connected to each other by means of binder uniformly. In addition, the binder and the polymer are admixed with each other and there is a plurality of microporosities on the surface of the electrode plate. Therefore, the electrode plate contacts with electrolyte and further the reaction area is also broadened so that it is possible to get the supercapacitor having high capacitance.

FIG. 5D is a photograph representing the microstructure of the polymer electrolyte membrane 501. From this photograph, it is understood that additives are distributed into the polymer electrolyte membrane 501 uniformly and there is a plurality of microporosities therein, whereby it is suitably utilized as the separator.

### EXAMPLE 22

Referring to FIGS. 6A and 6B, there are cross sectional views setting forth a unitary redox supercapacitor in accordance with the present invention.

After the electrode plates are cut off to be the desired shape, the electrode plates are disposed on a top and a bottom surfaces of the polymer electrolyte membrane 501, wherein one electrode plate is used as a positive electrode and the other one is used as a negative electrode. Thereafter, the positive electrode, the negative electrodes and the polymer separator are laminated by means of the roll press apparatus, thereby obtaining a unitary redox supercapacitor. Subsequently, the supercapacitor is put into a case and then the electrolyte is filled thereinto, wherein the electrolyte is prepared by dissolving 1 mole Et₄NBF₄ into acetonitrile.

### example 23

The capability of the unitary redox supercapacitor using polyaniline doped with lithium salt is measured under conditions that the specimen size is 3×6 cm, the thickness of the electrode plate provided with the foil is approximately 70 μm, the thickness of the separator is about 20 μm and the charge/discharge voltage ranges from 0.01 V to 1.0 V. Here, polyethylene separator is used as the separator.

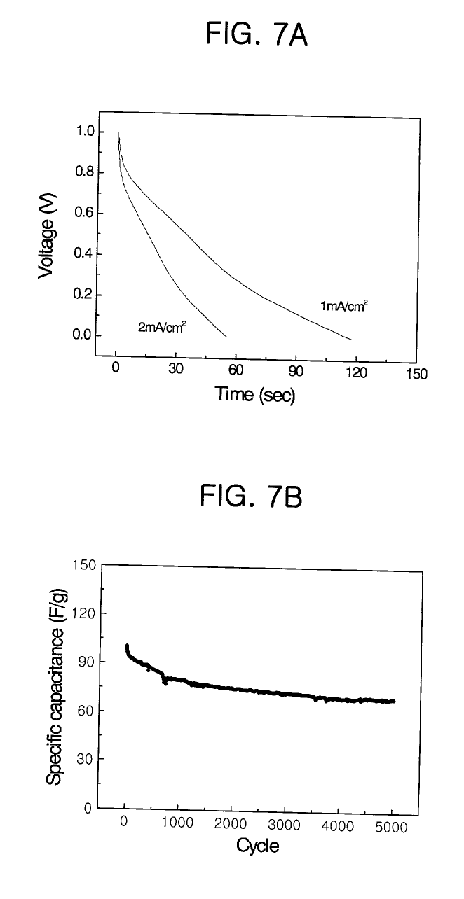

Referring to FIG. 7A, there is shown a graph setting forth discharge curves of the supercapacitor using polyaniline doped with lithium salt after charging and discharging 100 cycles by varying a discharge current. From these curves, it is understood that the discharge time is preserved for approximately 120 seconds under the discharge current of 1 mA/cm² and approximately 57 seconds under the discharge current of 2 mA/cm². That is, as the discharge current increases, the discharge time is shortened.

Referring to FIG. 7B, there is shown a graph representing a specific capacitance of the supercapacitor using polyaniline doped with lithium salt, which is measured under conditions that the discharge current is 2 mA/cm² and the charge/discharge time is 5,000 cycles. At an initial state, the specific capacitance is approximately 100 F/g. After 5,000 cycles, the specific capacitance is approximately 75 F/g.

### EXAMPLE 24

The capability of the unitary redox supercapacitor using polyaniline doped with lithium salt and the polymer electrolyte membrane 501 is measured under conditions that the specimen size is 3×6 cm, the thickness of the electrode plate provided with the aluminum foil is approximately 70 μm, the thickness of the polymer electrolyte membrane 501 is approximately 20 μm and the charge/discharge voltage ranges from 0.01 V to 1.0 V. Here, the electrode active material slurry is directly coated on the aluminum foil. In addition, the electrode plates and the polymer electrolyte membrane 501 are laminated under predetermined heat and pressure.

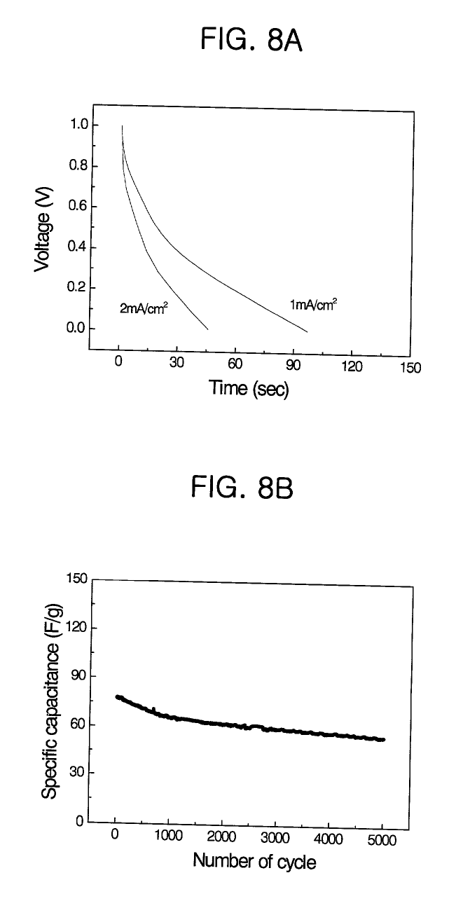

Referring to FIG. 8A, there is shown a graph setting forth discharge curves of the supercapacitor using polyaniline doped with lithium salt and the polymer separator after charging and discharging 100 cycles by varying a discharge current. From these curves, it is understood that the discharge time is preserved for approximately 100 seconds under the discharge current of 1 mA/cm² and approximately 45 seconds under the discharge current of 2 mA/cm². That is, as the discharge current increases, the discharge time is shortened.

Referring to FIG. 8B, there is shown a graph representing a specific capacitance of the supercapacitor using polyaniline doped with lithium salt and the polymer electrolyte membrane 501, which is measured under conditions that the discharge current is 2 mA/cm² and the charge/discharge time is 5,000 cycles. At an initial state, the specific capacitance is approximately 77 F/g. After 5,000 cycles, the specific capacitance is approximately 60 F/g. That is, the specific capacitance of the supercapacitor using the polymer electrolyte membrane is lower than that of the supercapacitor using the separator, as described in example 23.

### EXAMPLE 25

The capability of the unitary redox supercapacitor using polyaniline doped with lithium salt and proton acid is measured under conditions that the specimen size is 3×6 cm, the thickness of the electrode plate provided with the charge collector is approximately 110 μm, the thickness of the polymer separator is approximately 30 μm and the charge/discharge voltage ranges from 0.01 V to 1.0 V. Here, the electrode plate is fabricated by laminating the electrode active material films 302 and the charge collector 402 after the electrode active material films 302 are disposed on the mesh-typed charge collector 402, as shown in FIG. 4.

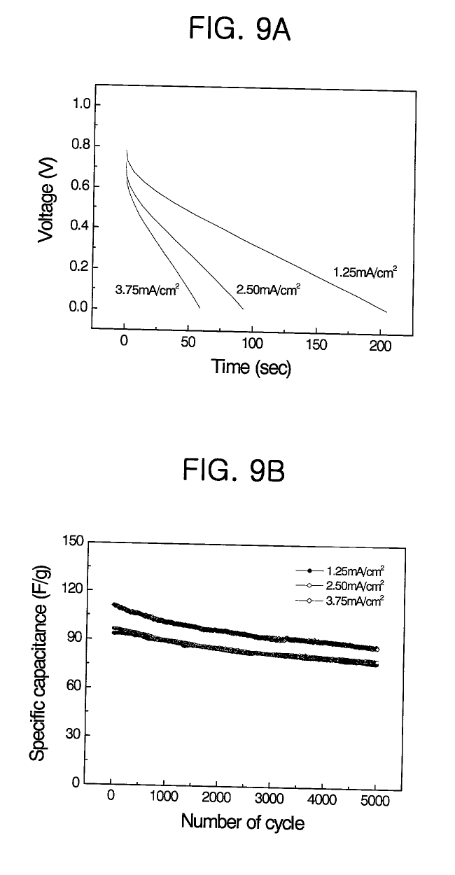

Referring to FIG. 9A, there is shown a graph setting forth discharge curves of the supercapacitor using polyaniline doped with lithium salt and proton acid after charging and discharging 100 cycles by varying a discharge current. From these curves, it is understood that the discharge time is preserved for approximately 210 seconds under the discharge current of 1.25 mA/cm², approximately 90 seconds under the discharge current of 2.5 mA/cm² and approximately 60 seconds under the discharge current of 3.75 mA/cm². That is, as the discharge current increases, the discharge time is shortened.

Referring to FIG. 9B, there is shown a graph representing the specific capacitance of the supercapacitor using polyaniline doped with lithium salt and proton acid after charging and discharging 5,000 cycles by varying a discharge current. At an initial state, the specific capacitance is approximately 110 F/g. After 5,000 cycles, the specific capacitance is approximately 95 F/g.

### EXAMPLE 26

The capability of the unitary redox supercapacitor using polyaniline doped with nucleophilic dopant and polymer electrolyte membrane 501 is measured under conditions that the specimen size is 3×6 cm, the thickness of the electrode plate provided with the charge collector is approximately 110 μm, the thickness of the polymer separator is approximately 30 μm and the charge/discharge voltage ranges from 0.01 V to 1.0 V. Here, the electrode plate is fabricated by laminating the electrode active material films 302 and the charge collector 402 after the electrode active material films 302 are disposed on the mesh-typed charge collector 402.

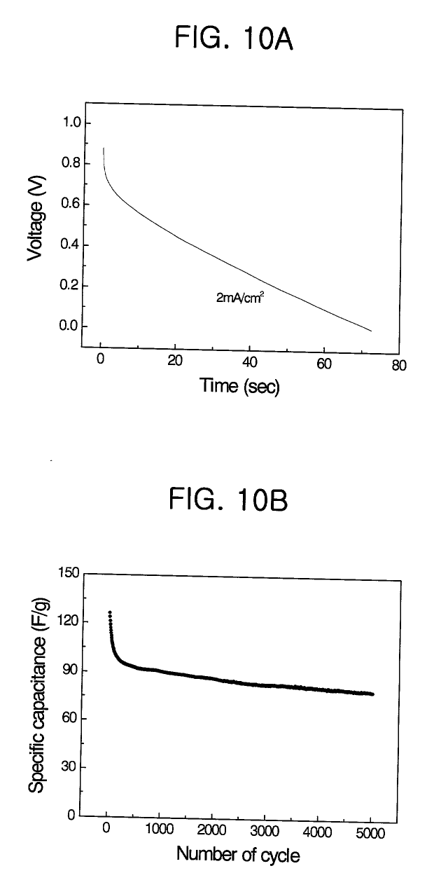

Referring to FIG. 10A, there is shown a graph setting forth discharge curves of the supercapacitor using polyaniline doped with nucleophilic dopant and the polymer electrolyte membrane 501 after charging and discharging 100 cycles. From these curves, it is understood that the discharge time is preserved for approximately 75 seconds under the discharge current of 1.25 mA/cm².

Referring to FIG. 10B, there is shown a graph representing the specific capacitance of the supercapacitor using polyaniline doped with nucleophilic dopant and the polymer electrolyte membrane 501, which is measured under conditions that the discharge current is 2 mA/cm² and the charge/discharge time is 5,000 cycles. At an initial state, the specific capacitance is approximately 130 F/g. After 5,000 cycles, the specific capacitance is approximately 85 F/g.

From this result, polyaniline doped with nucleophilic dopant, e.g., dimethylsulfate can be utilized for electrode material as well as polyaniline doped with lithium salt or proton acid, wherein nucleophilic dopant includes material having a radical such as methyl group, ethyl group or a large negative ionic structure.

As described already, the supercapacitor of the present invention has several advantages by using the conducting polyaniline powder for manufacturing the electrode plate. In comparison with the conventional electrical double layer capacitor (EDLC) and redox supercapacitor in which the electrode plate and the separator should be joined together under exterior pressure, the inventive redox supercapacitor has an advantage that the electrode and the separator are a unitary shape. Therefore, the surface resistance can be minimized. Furthermore, it is possible to manufacture the thin film supercapacitor with ease by virtue of simple manufacturing processes. In addition, the present invention provides the unitary supercapacitor so that various shapes of the supercapacitor may be fabricated.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A redox supercapacitor comprising:
a positive electrode plate incorporating therein a charge collector and an electrode active material, wherein the electrode active material is made by using a conducting polyaniline powder;
a negative electrode plate incorporating therein a charge collector and an electrode active material, wherein the electrode active material is made by using a conducting polyaniline powder; and
a polymer electrolyte membrane disposed between the positive electrode plate and the negative electrode plate.

2. The redox supercapacitor as recited in claim 1, wherein the conducting polyaniline includes a material selected from the group consisting of a polyaniline doped with a lithium salt and a polyaniline doped with nucleophilic dopant.

3. The redox supercapacitor as recited in claim 2, wherein the lithium salt includes a material selected from the group consisting of LiPF₆, LiPF₄, NaPF₆ and NaBF₄.

4. The redox supercapacitor as recited in claim 2, wherein the nucleophilic dopant is an organic dopant having a methyl group, an ethyl group or a large negative ionic structure.

5. The redox supercapacitor as recited in claim 4, wherein the nucleophilic dopant is dimethylsulfate.

6. The redox supercapacitor as recited in claim 3, wherein the positive and the negative electrode plates are formed by coating the electrode active material directly on the charge collector and drying the charge collector coated with the electrode active material.

7. The redox supercapacitor as recited in claim 4, wherein the positive and the negative electrode plates are formed by joining the charge collector and the electrode active material films together, after coating the electrode active material on a polymer film, drying the polymer coated with the electrode active material and separating the electrode active material film from the polymer film.

8. The redox supercapacitor as recited in claim 6, wherein the electrode active material is made using a binder solution of polyvinylidene fluoride (PVDF).

9. The redox supercapacitor as recited in claim 7, wherein the electrode active material is made using an organic polymer solution in which polyvinylidene fluoride and hexafluoropropylene (PVDF-HFP) is dissolved into acetone.

10. The redox supercapacitor as recited in claim 1, wherein the polymer electrolyte membrane is formed using nano-sized silica and a mixture in which PVDF-HFP is dissolved into acetone.

11. A method for manufacturing a redox supercapacitor comprising the steps of:
a) preparing an electrode active material including a conducting polyaniline therein;
b) forming a positive and a negative electrode plates incorporating therein the electrode active material and charge collectors; and
c) forming a polymer electrolyte membrane disposed between the positive and the negative electrode plates.

12. The method as recited in claim 11, wherein the step b) includes the steps of:
b1) coating the electrode active material on the charge collectors directly; and
b2) drying the charge collectors coated with the electrode active material.

13. The method as recited in claim 11, wherein the step b) includes the steps of:
b1) coating the electrode active material on a polymer film;
b2) drying the polymer film coated with the electrode active material;
b3) separating the electrode active material film from the polymer film;
b4) joining the charge collector and the electrode active material films separated from the polymer film, wherein the charge collector are disposed between the electrode active material films; and
b5) laminating the charge collector and the electrode active material films using a roll pressing apparatus.

14. The method as recited in claim 12, wherein the electrode active material is made using a polyaniline doped with a lithium salt.

15. The method as recited in claim 14, wherein the lithium salt includes a material selected from the group consisting of LiPF₆, LiPF₄, NaPF₆ and NaBF₄.

16. The method as recited in claim 13, wherein the electrode active material is made using a polyaniline doped with a nucleophilic dopant.

17. The method as recited in claim 16, wherein the nucleophilic dopant is an organic dopant having a methyl group, an ethyl group or a large negative ionic structure.

18. The method as recited in claim 17, wherein the nucleophilic dopant is dimethylsulfate.

19. The method as recited in claim 12, wherein the electrode active material is made using a binder solution of PVDF.

20. The method as recited in claim 13, wherein the electrode active material is made using an organic polymer solution in which PVDF-HFP is dissolved into acetone.

21. The method as recited in claim 11, wherein the polymer electrolyte membrane is formed using nano-sized silica and a mixture in which PVDF-HFP is dissolved into acetone.

22. The method as recited in claim 11, wherein the step a) includes the steps of:
a1) mixing the polyaniline doped with the lithium salt and a conductor in a solid powder state;
a2) putting a mixed powder into a binder organic solution and stirring it using a stirrer; and
a3) stirring a resultant mixture by means of a ball mill apparatus.

23. The method as recited in claim 11, wherein the step a) includes the steps of:
a1) mixing the polyaniline doped with the nucleophilic dopant and a conductor in a solid powder state;
a2) putting a mixed powder into acetone solution and stirring it using a stirrer; and
a3) stirring a resultant mixture by means of a ball mill apparatus.
